(19) United States
(12) Patent Application Publication
(10) Pub. No.: US 2007/0178042 A1
(43) Pub. Date: Aug. 2, 2007

(54) Sodium Alanate Hydrogen Storage Material

(75) Inventors: Terry A. Johnson, Livermore, CA (US); Daniel E. Dedrick, Oakland, CA (US); Robert D. Stephens, Sterling Heights, MI (US); Jennifer P. Chan, Fremont, CA (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/561,564

(22) Filed: Nov. 20, 2006

Related U.S. Application Data
(60) Provisional application No. 60/750,304, filed on Dec. 14, 2005.

(51) Int. Cl. C01B 6/24

(52) U.S. Cl. 423/644; 423/648.1

(57) ABSTRACT

A hydrogen storage material based on sodium alanate contains aluminum in excess of the stoichiometric aluminum content of sodium aluminum tetrahydride. A particulate mixture of sodium alanates, aluminum, and a suitable metal-containing catalyst readily yields, upon heating of the mixture, its hydrogen content for delivery to a hydrogen-using device. The excess aluminum facilitates the sorption of hydrogen, minimizes the amount of necessary catalyst, and improves packing of the particulate mixture and heat transfer to and from the mixture.

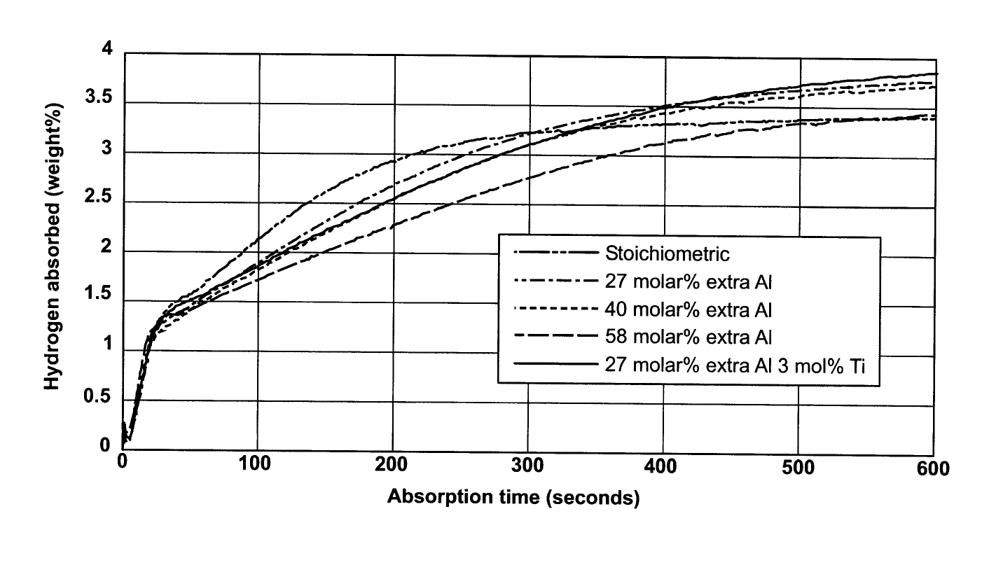

This application claims the benefit of U.S. Provisional Application No. 60/750304, titled “Sodium Alanate Hydrogen Storage Material,” filed Dec. 14, 2005, and which is incorporated herein by reference.

This invention was made in the course of work under a Funds-In Agreement No. FI 087030804 between the United States Department of Energy, General Motors Corporation, and Sandia National Laboratories.

### TECHNICAL FIELD

This invention pertains to the use of a re-chargeable sodium alanate-containing hydrogen storage system for fuel delivery to a hydrogen-consuming device. More specifically, this invention pertains to the use of an excess, non-stoichiometric quantity of aluminum in a reversible hydrogen desorption and absorption process.

### BACKGROUND OF THE INVENTION

Sodium alanates (NaAlH₄ and Na₃AlH₆) are being studied as possible hydrogen storage materials for hydrogen-using devices such as hydrogen/oxygen fuel cell powered vehicles. Sodium alanates reversibly absorb and desorb hydrogen in the presence of a catalyst (typically a titanium-based catalyst) at moderate temperatures and pressures (100° C. to 220° C. and about 150 bar). The two-step reversible reaction is described in the following equation (Equation 1):

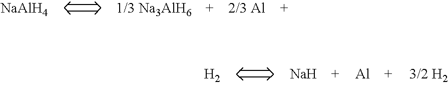

The theoretical reversible maximum hydrogen capacity of sodium aluminum tetrahydride is 5.6 wt % when hydrogen is removed to yield sodium hydride and aluminum. A catalyst is used to destabilize the system and promote both the release and uptake of hydrogen under moderate conditions. Although adding catalyst to the hydrogen storage material enables reversibility and improves kinetics, it also reduces the hydrogen capacity per unit weight of the fully hydrogenated mixture. Consequently, an amount of catalyst must be chosen to optimize the hydrogen capacity for any given set of reaction times and conditions. Further, it is found that the useful hydrogen capacity of sodium aluminum tetrahydride is less than 5.6 weight percent because the hydriding step to successively form Na₃AlH₆ and NaAlH₄ does not proceed to completion.

It has been recognized that the presence of excess aluminum plays a role in the hydrogenation of sodium hydride, aluminum and trisodium aluminum hexahydride (Na₃AlH6) to obtain more complete regeneration[d1] of the hydrogen-depleted sodium aluminum tetrahydride based hydrogen storage material. However, it has not been discovered how to most effectively use aluminum for this purpose[d2]. The presence of excess aluminum apparently contributes to more complete conversion (i.e., re-hydrogenation) of the hydrogen-depleted products back to sodium aluminum tetrahydride, but the aluminum itself does not absorb hydrogen. Consequently, there may be an optimal amount of aluminum that could be added to achieve greater hydrogen capacity relative to the weight of the constituents of the hydrogen-depleted mixture. Hydrogen-using devices (and vehicle applications in particular) require compact, light weight, and efficient fuel storage and delivery systems. The hydrogen capacity and sorption rate of the system must be optimized. An object of this invention is to provide a method of utilizing aluminum in conjunction with a metal catalyst to optimize hydrogen sorption performance for prescribed hydrogen refilling times of hydrogen-depleted [TAJ3]storage materials based on the sodium alanates.

### SUMMARY OF THE INVENTION

This invention provides an improved method for using sodium alanates as components of a hydrogen storage system. These improvements are especially well suited for delivery of hydrogen to a hydrogen-consuming device, such as a fuel cell that is powering a vehicle. Vehicular applications demand optimized fuel capacity per unit volume and weight of the fuel delivery system.

A hydrogen storage system utilizing sodium alanates operates in accordance with the successive reversible chemical reactions presented in Equation 1. A suitable catalyst is added to promote reversibility and increased kinetics of the system. The fuel delivery system contains the sodium alanate mixture in a suitable storage vessel. As hydrogen is required by a fuel cell, or other hydrogen-using device, the vessel may be heated to a suitable temperature for hydrogen release. NaAlH₄ decomposes to release hydrogen and form Na₃AlH₆ and aluminum (Al), and Na₃AlH₆ decomposes to form sodium hydride and aluminum.

After complete dehydrogenation, the remaining material in the vessel is usually a solid particulate mixture of sodium hydride, aluminum metal, and titanium or a titanium compound, or other catalyst, if added. While the release of hydrogen from NaAlH4 proceeds to completion, the complete regeneration to NaAlH4 from the hydrogen-depleted material is not as readily accomplished. The hydrogen content of the storage material is restored by adding hydrogen to the vessel under suitable pressure and at a suitable temperature to form Na₃AlH₆ and then NaAlH_{4.} These reactions are exothermic and the storage material may have to be cooled to maintain a desired re-hydrogenation temperature and/or to retain the reformed sodium aluminum tetrahydride. Titanium, or other suitable catalyst material, promotes these reactions. Additionally, in accordance with this invention, controlled excess amounts of aluminum are added such that a re-hydrogenated mixture contains mostly small particles of NaAlH₄ and aluminum. The catalyst is also present in some form in the mixture.

Thus, the initial hydrogen storage material is formulated with elemental aluminum powder in addition to the aluminum content of sodium aluminum tetrahydride. For example, if it is determined to prepare a hydrogen storage material with a twenty molar percent excess of aluminum with respect to NaAlH₄, the initial storage material would contain twenty moles of aluminum powder for each one hundred moles of sodium aluminum tetrahydride (or as sometimes abbreviated in this specification: 100 Na: 120 Al). The initial material may also contain a catalyst or catalyst precursor. The amount of catalyst and aluminum, in addition to NaAlH₄, is managed to maximize sorption of hydrogen within a desired reaction time and from a given mass or volume of storage material over repeated hydrogen desorption and absorption cycles. Preferably, the content of the relatively expensive catalyst is minimized to reduce the cost of the hydrogen storage system.

In addition to increasing the amount of recovered NaAlH₄ and the rate at which hydrogen is absorbed, it is found that the addition of aluminum powder may also be used to improve packing of the mixture that includes non-metallic particles of Na₃AlH₆ and NaH. The aluminum powder may also be used to improve heat transfer to and from the particulate mass.[d4] In most applications the hydrogen storage material is heated to release hydrogen and then cooled when hydrogen is reacted with the depleted material. Therefore, the amount of aluminum added to the hydrogen storage material is predetermined to optimize the overall usage and performance of the particulate mixture. Improved packing is important in increasing the volumetric efficiency of the system and improved heat transfer is vital in improving thermal management of the system. Thus, in accordance with a practice of the invention, an initial hydrogen storage mixture is formulated (by experiment or experience) to contain specified amounts of sodium aluminum tetrahydride particles, aluminum particles (in excess of the formula requirement of NaAlH₄), and catalyst or catalyst precursor to obtain a desired combination of thermal conductivity and gravimetric and/or volumetric efficiency of usage of the material in hydrogen desorption and re-sorption.

Other objects and advantages of the inventions will become apparent from the following description of preferred embodiments.

### BRIEF DESCRIPTION OF THE DRAWINGS

The drawing FIGURE is a graph of hydrogen absorbed, in weight percent, vs. absorption time for five different sodium alanate formulations. The data curve (- -- -) is for the synthesis of NaAl, with a stoichiometric amount of aluminum. The data curve (- - - -) is for the synthesis of NaAlH₄ with 12% by weight (27 molar percent) excess of aluminum. The data curve (- - - -) is for the synthesis of NaAlH₄ with 18% by weight (40 molar percent) excess of aluminum[d5]. The data curve (- - -) is for the synthesis of NaAlH₄ with 26% by weight (58 molar percent) excess of aluminum. The solid line data curve represents an alanate formulation with only 3 mole percent titanium catalyst and 27 molar percent excess of aluminum.

### DESCRIPTION OF PREFERRED EMBODIMENTS

In order to have practical value for vehicle applications, a hydrogen storage material must give up its hydrogen as needed (i.e., intermittently or continuously) under moderate conditions and, after hydrogen depletion, be capable of quickly reabsorbing hydrogen. Moreover, the system may have to satisfy volume or weight limitations and it must accommodate efficient heat transfer for thermal control.

The practice of this invention is based on the use of a non-stoichiometric excess of aluminum in conjunction with an amount of metal catalyst to optimize the formation of NaAlH₄. Furthermore, the excess of aluminum particles may be used to improve packing (densification) of the particulate system and to improve thermal conductivity of the system. Indeed, the optimization of the alanate hydrogen storage system involves a balancing of NaAlH₄ formation rate, densification of the material mixture, and its thermal conductivity.

The re-formation of NaAlH4 in hydrogen-depleted storage material is accomplished by the addition of hydrogen to aluminum, sodium hydride and/or Na₃AlH₆. The managed use of an excess of aluminum results in greater recovery (synthesis) of sodium aluminum tetrahydride[d6] from its de-hydrogenated products, and also dramatically increases the sorption[d7] rate of hydrogen. Thus, an excess of aluminum, with respect to the aluminum content of NaAlH₄, yields a higher recovery of NaAlH₄. Additionally, the rate at which hydrogen is absorbed in the successive reactions is variable with the amount of added aluminum. Consequently, for any finite absorption time, there is an optimal amount of added excess aluminum, in conjunction with an amount of metal catalyst, which is independent of that amount needed for maximum hydrogen absorption at infinite time. The mechanism responsible for this effect is not yet fully understood[d9] but may be based on increased aluminum surface area and/or improved interaction between the catalyst and aluminum particles.

This invention involves determining an optimum amount of excess aluminum, in conjunction with an amount of metal catalyst, that will produce optimal hydrogen storage system capacity for a given absorption [d10]time and other system parameters and requirements. This system optimization is typically experimentally based. The “system” refers to the hydride (NaAlH₄ and its reaction products), the vessel containing the hydride, and the cooling and the heating systems for the vessel. The system may also include a conduit for “on-demand” transfer of released hydrogen to the vehicle's hydrogen-using device, and a conduit for adding replacement hydrogen to hydrogen-depleted material in the vessel. Consequently, system capacity for any given absorption time is affected by a number of inter-dependent factors, including but not limited to the reversible hydrogen capacity, the hydride packing density, the sorption kinetics[d11], and the heat transfer within the system. Excess aluminum enhances each of these parameters and the degree of enhancement for any given absorption time depends upon the amount of added aluminum.

Experiments have been performed on the synthesis of sodium aluminum tetrahydride[d12] from Al, NaH, Na₃AlH₆, and hydrogen with excesses of aluminum over the amount required to form NaAlH₄. The reaction to sodium aluminum tetrahydride (NaAlH₄) reaches higher completion in the presence of excess aluminum which yields a higher net system hydrogen storage and recovery capacity. Heat transfer within the packed particle bed is improved due to the addition of high conductivity aluminum. The packing density of the packed bed is also increased along with improved kinetics for the reaction of hydrogen with the sodium alanate precursors (see the following table and the drawing FIGURE). The amount of extra aluminum can be optimized for any specified hydrogen absorption time and conditions, and for catalyst requirement.

There are several ways in which to make a catalyzed sample of sodium alanate (NaAlH₄). Broadly speaking, there are two main categories: wet chemical synthesis and dry mechanical synthesis (direct synthesis). The material used in the following examples was prepared using direct synthesis in which precursor materials, including a catalyst and excess aluminum, are ball milled to reduce particle size and to obtain a uniform mixture for reaction with hydrogen. However, the practice of this invention in not limited to any specific preparation technique for sodium alanate.

Many catalysts for these reversible de-hydrogenation/hydrogenation reactions have been used including titanium, tin, scandium, and zirconium. TiCl₃ is a common Ti catalyst precursor used for the synthesis of sodium alanates. Most often the mixture contains amounts of these constituents in the molar ratio of 100:100:2-4 for Na:Al:Ti (excluding the Na that forms NaCl during the ball milling process when using TiCl₃). During the synthesis using TiCl₃, stoichiometric amounts of hydrogen are produced in conjunction with the formation of NaCl, which adds non-reactive mass to the hydride. While the titanium (or other catalyst) may initially be deposited on the sodium aluminum tetrahydride, its location following dehydrogenation and any subsequent hydrogenation is unknown. But the catalyst is in the storage material and it does enhance both reactions.

Experiments have been conducted with molar ratios for Na:Al:Ti (exclusive of Na salts that might be formed by using certain catalyst precursors) of 100:100:4, 100:127:4, 100:127:3, 100:140:4, and 100:158:4. These samples were prepared starting with powders of NaH, Al, and TiCl₃ and milling them together with a planetary ball mill. Other Ti catalyst precursors can be used. These samples are representative of hydrogen depleted sodium alanates were used in hydrogenation reactions to generate NaAlH₄.

NaAlH₄ contains molar (or atomic) equivalent amounts of sodium and aluminum and, as stated above, a first hydrogen absorption experiment was performed with equal molar proportions of these elements with a 4% molar portion of titanium catalyst. The rate of hydrogen absorption was measured using a volumetric Sieverts-type instrument over a period of about 1000 seconds. This absorption data in weight percent hydrogen absorbed versus time in seconds is summarized in the FIGURE in the curve of (- -- -) data points. In this FIGURE, the hydrogen storage capacity of produced NaAlH₄[d13] is defined as mass of hydrogen stored divided by the total mass of hydride plus titanium as prepared.

The first data row of the following table summarizes the acquired capacity of the mass of regenerated hydride containing material after hydrogen absorption times of one minute, five minutes, and ten minutes respectively. The first data row of the table also summarizes thermal conductivity of the powder mixture both in the fully desorbed state and the fully absorbed state. Also presented is the projected density to which the milled powder could be packed within a storage vessel.

Milled powder mixtures with excess aluminum in molar ratios of 100:127:4, 100:140:4, 100:127:3, and 100:158:4 were also prepared and subjected to hydrogenation[d14]. The molar mixture 100:127:4 [d15]was hydrogenated and hydrogen absorbed as a function of time, expressed in weight percent, is depicted by the (- - -) line in the drawing FIGURE. Similar data for the molar mixtures 100:140:4 and 100: 158:4 were also obtained and are depicted in the FIGURE by the (- - -) line and the (- -) line, respectively. Data were also obtained for the molar mixture 100:127:3 and the data are depicted in the FIGURE as the solid line. The data in the FIGURE presents weight of hydrogen absorbed as a percentage of the total weight of hydrogen storage material. It is to be recognized that as the mass is increased by larger aluminum or catalyst content, a given mass of absorbed hydrogen will represent a lower percentage of the total weight of storage material. Thus, the FIGURE does not depict the volumetric and thermal benefits of aluminum content.

All hydrogenation data producing experiments summarized in the FIGURE utilized initial conditions of 135° C. to 145° C. and 1450 to 1800 psi. Temperatures rose from these minima according to the exothermicity of the reactions.

| | 1 min | 5 min | 10 min | | | |
|---|---|---|---|---|---|---|
| Molar | Capacity | Capacity | Capacity | Thermal Conductivity | | Projected Packing |
| Mixture | (wt %)* | (wt %)* | (wt %)* | Desorbed | Absorbed | Density (g/cc)** |
| 100:100:4 | 1.69 | 3.23 | 3.41 | 2.4 | 1.1 | 1.0 |
| 100:127:4 | 1.56 | 3.22 | 3.78 | 3.2 | 1.7 | 1.09 |
| 100:127:3 | 1.57 | 3.11 | 3.86 | | | |
| 100:140:4 | 1.51 | 3.11 | 3.72 | | | 1.13 |
| 100:158:4 | 1.5 | 2.78 | 3.44 | | | 1.17 |

*Capacity is defined as mass of hydrogen stored divided by total mass of hydrogenated material as prepared. Three absorption times are listed to illustrate the effect of kinetics.
**Projected packing density is based on a constant percentage of the theoretical minimum single crystal mixture density.

Based on the above table, it is seen that adding 27 molar percent excess of aluminum would improve the thermal conductivity of the alanate by a minimum of 33%. In addition, the gravimetric hydrogen capacity for a 10 minute refill increases by 11% and the packing density increases by 9% for an overall volumetric improvement in hydrogen capacity of 21% at ten minutes refilling time. Consequently, system gravimetric and volumetric efficiencies are significantly enhanced with alanate formulated with Na:Al:Ti molar ratios consisting of excess aluminum, e.g., of 100:140:4, 100:127:3, and 100:127:4. The improvement in hydrogen sorption kinetics due to excess aluminum also allows for a reduction in added titanium catalyst without loss of hydrogen capacity for some absorption times (e.g., 10 minutes absorption time) as shown in the FIGURE for the case of 27 molar percent excess aluminum and three mole percent titanium.

The improvement in thermal conductivity of the alanate formulation that arises from the use of excess aluminum allows for the use of larger cross-sectional areas of alanate for any given desired temperature gradient through the alanate. In general, the sodium aluminum alanate based hydrogen storage material of this invention is heated to release hydrogen and cooled when pressurized hydrogen is reacted with the depleted material. The presence of the aluminum particles intimately mixed with the other material particles markedly improves the thermal conductivity of the hydrogen storage mixture. Consequently, the volume of alanate content relative to overall system volume (including heat exchangers, valves, piping, etc.) increases, providing for greater overall system gravimetric and volumetric storage efficiencies.

Aluminum specifically enhances the sorption performance and thermal conductivity of sodium alanate. This invention can be applied to other unspecified systems if the enhancing component has a similarly vital role in the sorption reaction.

This invention will result in an optimized system for using sodium alanate as a hydrogen storage medium on-board automobiles. It will increase both volumetric and gravimetric system energy densities which are the two most important parameters for on-board hydrogen storage systems.

The invention has been illustrated in terms of certain specific embodiments but the scope of the invention is not limited to these examples.

1. A method of operating a hydrogen storage system for delivery of hydrogen to a hydrogen-using device, the method comprising:
adding a predetermined quantity of a hydrogen-containing particulate mixture to a hydrogen storage vessel, the particulate mixture comprising sodium aluminum tetrahydride, aluminum, and a metal-containing catalyst;
heating the particulate mixture in the storage vessel, upon a demand for hydrogen for the hydrogen-using device, to a hydrogen-release temperature to release hydrogen for delivery to the hydrogen-using device and to successively form Na₃AlH₆ and then NaH and Al; and, when the hydrogen content of the particulate mixture reaches a hydrogen-depleted level,
adding hydrogen under pressure to the hydrogen-depleted particulate mixture in the vessel while cooling the particulate mixture to facilitate reaction of hydrogen with NaH, Al, and Na₃AlH₆ to re-form NaAlH₄ in the particulate mixture to a hydrogen-restored level for the particulate mixture;
the aluminum content of the added particulate mixture being predetermined for a prescribed reaction time to reach the hydrogen-restored level with a desired catalyst content.

2. A method of operating a hydrogen storage system as recited in claim 1 in which the aluminum content of the added particulate mixture is also predetermined to facilitate the transfer of heat to and from the particulate mixture.

3. A method of operating a hydrogen storage system as recited in claim 1 in which hydrogen is repeatedly withdrawn from the sodium alanate content of the vessel for the hydrogen-using device and, upon depletion of hydrogen from the vessel, hydrogen is repeatedly added to the vessel to reform sodium alanate.

4. A method of operating a hydrogen storage system as recited in claim 1 in which the catalyst comprises one or more metals selected from the group consisting of titanium, tin, scandium, and zirconium. [d16]

5. A method of operating a hydrogen storage system as recited in claim 1 in which the aluminum content of the added particulate mixture is at least a 25% of the aluminum content of the added NaAlH₄.

6. A method of operating a hydrogen storage system as recited in claim 1 in which the aluminum content of the added particulate mixture is at least a 40% of the aluminum content of the added NaAlH₄.

7. A hydrogen storage material for providing hydrogen to a hydrogen-consuming device from a vessel of predetermined capacity, the storage material being composed for cycling between a hydrogen-containing condition and a hydrogen-depleted condition, the storage material initially comprising a particulate mixture of sodium aluminum tetrahydride, aluminum, and a metal-containing catalyst, and where the aluminum content is predetermined for a prescribed hydrogenation reaction time in the vessel to reach a hydrogen-restored level with a desired catalyst composition and content.

8. A hydrogen storage material as recited in claim 7 in which the catalyst comprises one or more metals selected from the group consisting of titanium, tin, scandium, and zirconium. [d17]

9. A hydrogen storage material as recited in claim 7 in which the aluminum content is at least equivalent to 40% of the aluminum content of the NaAlH₄.

10. A hydrogen storage material as recited in claim 7 in which the catalyst comprises titanium.
